(19) United States
(12) Patent Application Publication
(10) Pub. No.: US 2015/0099054 A1
(43) Pub. Date: Apr. 9, 2015

(54) High Saturated Fat Mayonnaise

(71) Applicant: Dan Steinberg, Blacksburg, VA (US)

(72) Inventor: Dan Steinberg, Blacksburg, VA (US)

(21) Appl. No.: 14/046,943

(22) Filed: Oct. 5, 2013

(51) Int. Cl. A23L 1/24

(52) U.S. Cl. CPC A23L 1/24
USPC 426/605

(57) ABSTRACT

A mayonnaise product in which the oil phase includes a combination of medium chain triglyceride (MCT) oil and a saturated fat such as butter oil, coconut oil, lard or palm oil. The MCT oil tends to reduce crystallization of the saturated fat when cooled, and consequently this improves emulsion stability. In another embodiment, the mayonnaise contains ascorbyl palmitate in an amount sufficient to reduce the size of fat crystals when cooled. In another embodiment, the oil phase also contains up to about 40% vegetable oil such as olive oil or high oleic sunflower oil. In another embodiment, the mayonnaise contains whole butter. In this embodiment, the aqueous portion of the whole butter improves emulsion stability.

### RELATED APPLICATIONS

The present application claims the benefit of priority from provisional patent applications 61/744,937 filed on Oct. 5, 2012, 61/848,474 filed on Jan. 4, 2013, and 61/849,328 filed on Jan. 24, 2013.

### FIELD OF THE INVENTION

The present invention relates generally to mayonnaise and oil-in-water emulsion food products. More specifically, the present invention relates to a mayonnaise product containing medium-chain triglyceride oil in combination with a saturated fat such as butter, coconut oil, or lard.

### BACKGROUND OF THE INVENTION

Awareness has been growing that saturated fats are not unhealthy and do not cause heart disease. Recent scientific reviews and reports have contradicted the long-held belief that saturated fats cause disease. See for example “Meta-analysis of prospective cohort studies evaluating the association of saturated fat with cardiovascular disease” Am. J. Clin. Nutr. 10.3945/ajcn.2009.27725 and “Saturated fat and cardiovascular disease: The discrepancy between the scientific literature and dietary advice” Nutrition Vol. 28 (2012) 118-123. Further, some studies and clinical reports demonstrate beneficial effects from saturated fat consumption, especially the medium chain triglycerides (with chain lengths of 8 carbons and 10 carbons, C:8 and C:10).

Also, in recent years there has been growing awareness of the dangers of excessive intake of omega-6 unsaturated fats. Omega 6 fats tend to promote inflammation. Also, omega-6 fats tend to increase lipid peroxidation in the body. Both these effects are harmful and tend to promote diseases such as heart disease, diabetes, and cancer.

Almost all commonly marketed mayonnaise products are made with oils containing large amounts of omega-6 fats (linoleic acid), such as soybean oil, canola oil, peanut oil, cottonseed oil or the like. A growing number health-conscious people are avoiding the use of these high omega-6 vegetable oils. For example, those following a “paleo” diet avoid omega-6 vegetable oils, and prefer saturated fats.

Also, the refined omega-6 vegetable oils have bland flavor and lack nutrients since they are highly processed. Consequently, mayonnaise made with refined liquid vegetable oils is bland and lacks nutrients. Health conscious consumers seek alternative mayonnaise products made with healthier and more flavorful oils.

Mayonnaise can be made with olive oil, which has a relatively low omega-6 content of about 10%. However, unrefined olive oil has a strong flavor that can be overpowering in mayonnaise, since mayonnaise typically comprises at least about 65% oil.

Mayonnaise cannot be made with a highly saturated fat (e.g. butter oil, coconut oil, lard or palm oil) alone because these fats crystallize strongly when refrigerated. This crystallization breaks the emulsion and causes the oil to leak, which is highly undesirable in a mayonnaise product. Also, a mayonnaise made with butter oil, coconut oil, lard or palm oil will become too hard to spread when refrigerated; it can only be served heated. For these reasons, a mayonnaise made with these oils is not marketable.

Accordingly, there is a need for a stable mayonnaise with a high saturated fat content.

### SUMMARY

The present invention includes an oil-in-water emulsion mayonnaise food product comprising a continuous acidic aqueous phase, egg yolks, egg whites, and a discontinuous oil phase made of oil droplets comprising medium-chain triglyceride oil and a saturated fat (SF) selected from the group consisting of butter oil, coconut oil, lard and palm oil. MCT oil and SF are present in a ratio in the range 35-85% MCT:15-65% SF. The MCT oil tends to inhibit fat crystallization and improve emulsion stability.

The MCT and SF can alternatively be present in a ratio in the range 40-60% MCT:60-40% SF.

Liquid vegetable oil can also be present in an amount of up to 40% of the oil content or 10-25% of the oil content. Suitable liquid vegetable oils include olive oil, high oleic sunflower oil, high oleic safflower oil, canola oil, soybean oil, corn oil, and peanut oil for example.

The present mayonnaise can also include up to about 0.5% ascorbyl palmitate, which helps to improve emulsion stability when exposed to temperature cycling.

The present mayonnaise can also include up to about 0.2% sodium phytate, which also helps to improve emulsion stability when exposed to temperature cycling. Sodium phytate also inhibits iron-catalyzed lipid peroxidation, an effect which is known in the art.

The present mayonnaise can also comprise aqueous butter fraction (ABF), the non-lipid portion of whole butter. Whole butter can be used as an ingredient in the present mayonnaise product. ABF and butter oil can be present in a ratio of about 75-90% butter oil:10-25% ABF. Whole butter typically contains butter oil and ABF in this ratio range.

### DETAILED DESCRIPTION

The present invention provides a mayonnaise product with a high saturated fat content, and a low omega-6 content. The present mayonnaise has a stable emulsion that does not break or leak significantly even when exposed to multiple heating and cooling cycles.

Saturated fats in butter, coconut oil, palm oil or lard can create emulsion stability problems when used in mayonnaise because they crystallize when refrigerated and can even crystallize at room temperature. Fat crystals break an oil-in-water emulsion, causing oil leakage/separation and rendering the product undesirable for consumers. The present invention provides a high saturated fat mayonnaise product that does not suffer from this problem.

In mayonnaise made according to the present invention, the oil phase comprises a saturated fat (butter oil, coconut oil, lard or palm oil) in combination with medium-chain trilgyceride oil (MCT oil). The MCT oil inhibits crystallization of the saturated fat, thereby greatly improving the emulsion stability. Also, the addition of MCT oil softens the mayonnaise, so that it is spreadable even when refrigerated. Hence, MCT stabilizes the emulsion during refrigeration.

Accordingly, the present invention provides a mayonnaise with a high saturated fat content and low omega-6 content that does not suffer from emulsion instability and oil leakage when exposed to temperature cycling or freeze-thaw cycling (e.g. cycling between refrigerator temperature and room temperature).

### Definitions

Mayonnaise: An oil-in-water emusion comprising at least 60% oil, an egg yolk or other phospholipid (e.g. lecithin) surfactant/emulsifier, and an acidified aqueous phase. Mayonnaises can comprise about 60-90% oil, and more typically will comprise about 65-80% oil.

Butter oil: the lipid component of butter. Also known as clarified butter, anhydrous butter oil, or ghee. Whole butter typically comprises about 85% butter oil.

Aqueous butter fraction (ABF): The aqueous component of butter, comprising water and proteins and dissolved minerals. Typically, ABF comprises about 10-25%, or about 14-18% of whole butter. ABS may further comprise salt (if the butter is salted, for example).

Whole butter: Butter oil+aqueous butter fraction.

Medium-chain triglyceride oil (MCT): A triglyceride oil comprising more than 85% or 90% caprylic (C:8) and capric (C:10) fatty acids (in the form of triglycerides). MCT may also contain small amounts (less than 5%) of caproic (C:6) and lauric (C:12) acids. MCT oil is also sometimes referred to as “fractionated coconut oil”, or “fractionated palm kernel oil”. MCT is made from a light fraction of coconut and/or palm kernel oil. MCT oil is essentially 100% saturated. MCT is also known as medium chain triacylglycerols. MCT may be the product of transesterification.

Saturated fat (SF): A food ingredient comprising a high saturated fat content (e.g. greater than about 35% saturated). Examples include butter oil, coconut oil, lard or palm oil for example. An oil described as SF herein will typically not be 100% saturated. Butter oil is typically about 60-65% saturated, coconut oil is typically about 90% saturated, palm oil is typically about 50% saturated, and lard is typically about 40% saturated.

Oil-in-water emulsion: An emulsion in which the aqueous phase is the continuous phase. An emulsion comprising oil droplets dispersed in an aqueous phase. Mayonnaise is an oil-in-water emulsion.

All percentages and ratios in the present description are by weight.

A mayonnaise made according to the present invention comprises a discontinuous oil phase, a continuous aqueous phase, and an emulsifier. Typically, the emulsifier will comprise egg yolk or lecithin, as known in the art. The aqueous phase is acidic, as known in the art. The aqueous phase can contain lemon juice and vinegar, as known in the art. The aqueous phase can also contain other organic acids, such as citric acid, malic acid, phosphoric acid of mixtures thereof for example. The aqueous phase can have a pH in the range of about 3.2-4.2 for example. Also, the aqueous phase can contain flavor enhancing ingredients like salt, sugar, flavor extracts, or mustard seed for example.

The discontinuous oil phase comprises oil droplets made of a combination of a saturated fat (e.g. butter oil, coconut oil, palm oil, lard or mixture thereof) and medium-chain triglyceride (MCT) oil. The ratio of MCT oil to saturated fat (SF) will be about 35MCT/65SF to about 85MCT/15SF. Optionally, the ratio is about 40MCT/60SF to about 60MCT/40SF. A MCT/SF ratio in this range will tend to inhibit fat crystallization and improve emulsion stability, while still providing the rich texture and flavor provided by natural saturated fats such as butter oil, coconut oil, lard and palm oil.

The MCT/SF oil blend will be mostly liquid at room temperature, though it may contain a small amount of fatty acid crystals.

The optimal amount of MCT oil depends on the crystallization tendency of the saturated fat, and the optional presence of other fats or oils. Fats with a higher saturated fat content and longer fatty acids have a stronger tendency to crystallize, and will therefore require a larger proportion of MCT oil. Also, the amount of MCT oil necessary will depend on the desired hardness of the mayonnaise, and the desired emulsion stability. Softer mayonnaise will generally require a higher proportion of MCT oil. Higher emulsion stability and greater resistance to oil leakage will also generally require a higher proportion of MCT oil.

MCT oil, like any naturally derived oil, contains a mixture of different fatty acids. MCT contains primarily (e.g. over 90%) caprylic (C:8) and capric (C:10) acids, and small amounts of other fatty acids. Caprylic acid is a smaller molecule, and therefore has a stronger crystallization-inhibiting effect than capric acid. Hence, slightly smaller amounts of MCT oil can be used if the MCT oil contains a higher proportion of caprylic acid. A typical MCT oil composition is C 6:2%, C 8:57%, C 10:40%, and C 12:<1%. Some types of MCT oil can contain about 70% C8 and 30%C10. All these variations of MCT are within the scope of the present invention. At least about 85% or 90% of the MCT should comprise caprylic+capric acid-containing triglycerols.

The MCT-SF mixture is not transesterified. It is a mixture of triglycerides. The MCT oil ingredient may be a product of transesterification, however.

Total oil content of the mayonnaise can be about 50-90% or about 65-80%, as is typical for mayonnaises.

### EXAMPLE 1

258 grams pasteurized egg yolks

200 g pasteurized egg whites

100 g lemon juice

50 g water

75 g vinegar (5% strength)

15 g salt

12 g mustard seed powder

1020 g MCT oil

835 g Butter oil

### Method:

1) Blend yolks, whites, lemon juice, water, vinegar, salt and mustard seed ingredients (aqueous ingredients).
2) Combine MCT oil and melted butter oil. Blend to uniformity.
3) While vigorously mixing aqueous ingredients, slowly add MCT/butter oil mixture.
Total non-oil ingredients: 710 grams
Total oil ingredients: 1855 grams
Oil content: 72.3%
MCT/SF ratio: 55%/45%
Saturated fat content of oil phase (assuming butter oil is 66% saturated and MCT is 100% saturated): 84.6%
Result: Stable mayonnaise with good resistance to oil leakage from temperature cycling.

In an alternative embodiment, the oil phase comprises a vegetable oil in combination with the MCT/SF oil blend. For example, the oil phase can comprise up to about 40% vegetable oil, with the balance being a combination of MCT and SF. Adding a liquid vegetable oil will tend to reduce cost, and will also further improve emulsion stability.

The liquid vegetable oil can be canola, soybean, safflower, olive or sunflower oil for example. High oleic oils (e.g. high oleic sunflower or high oleic safflower) are preferred for their low omega 6 content. For example, the present mayonnaise can comprise 65% MCT/SF blend, and 35% high oleic safflower oil or olive oil. A high oleic-acid oil will generally be preferred because it will contribute little omega 6. For example, high oleic safflower oil will typically contain about 10-20% omega 6 fatty acids, and high-oleic sunflower oil will typically contain about 5-10% omega 6 fatty acids.

Liquid vegetable oils such as canola, soybean, safflower, olive, sunflower oil, and the high-oleic oils will typically have a freezing temperature less than 45F.

### EXAMPLE 2

70 grams pasteurized egg yolks

35 g pasteurized egg whites

40 g vinegar (5% strength)

7 g lemon juice

7 g honey

3 g salt

2 g mustard seed powder

134 g butter oil

148 g MCT oil

16 g high oleic sunflower oil

### Method:

1) Blend yolks, whites, lemon juice, water, vinegar, salt and mustard seed ingredients (aqueous ingredients).
2) Blend MCT oil, melted butter oil and high oleic sunflower oil.
3) While vigorously mixing aqueous ingredients, slowly add MCT/butter oil/sunflower oil mixture.
Total non-oil ingredients: 164 grams
Total oil ingredients: 298 grams
Oil content: 64.5%
MCT/SF ratio: 52.5%/47.5%
Vegetable oil content (of oil component): 5%
Result: Stable mayonnaise with good resistance to oil leakage from temperature cycling.

### EXAMPLE 3

70 grams pasteurized egg yolks

35 g pasteurized egg whites

40 g vinegar (5% strength)

7 g lemon juice

7 g honey

3 g slant

2 g mustard seed powder

104 g butter oil

100 g MCT oil

86 g high oleic sunflower oil

### Method:

1) Blend yolks, whites, lemon juice, water, vinegar, salt and mustard seed ingredients (aqueous ingredients).
2) Blend MCT oil, melted butter oil, and high oleic sunflower oil.
3) While vigorously mixing aqueous ingredients, slowly add MCT/butter oil/sunflower oil mixture.
Total non-oil ingredients: 164 grams
Total oil ingredients: 290 grams
Oil content: 63.8%
MCT/SF ratio: 49%/51%
Vegetable oil content (of oil component): 29.6%
Result: Stable mayonnaise with good resistance to oil leakage from temperature cycling. Oil leakage resistance better than examples 1 and 2.

In another embodiment of the present invention, whole butter is used as an ingredient instead of butter oil. Whole butter consists of butter oil in combination with an aqueous butter fraction (ABF). The ABF primarily comprises water, dissolved minerals and milk proteins. Whole butter is required by law to contain at least 80% butter oil. Typically, whole butter will contain about 82-86% butter oil. It is important to know the butter oil content of whole butter used in the present invention, so that a desired MCT/SF ratio and total fat content can be obtained. The MCT/SF ratio is calculated from the butter oil content (i.e. the SF is the butter oil component of the whole butter).

The ABF contains desirable flavor components, and emulsifying compounds that can help form and stabilize the emulsion. In all descriptions herein, when butter oil is indicated as an ingredient, the actual ingredient used may be a commensurate amount of whole butter (i.e. whole butter containing the indicated amount of butter oil).

### EXAMPLE 4

170 grams pasteurized egg yolks

200 g pasteurized egg whites

100 g lemon juice

250 g vinegar (5% strength)

12 g salt

12 g mustard seed

1000 g whole butter (comprising about 850 g butter oil and 150 g ABF)

812 g MCT oil

226 g high oleic sunflower oil

### Method:

1) Blend yolks, whites, lemon juice, water, vinegar, salt and mustard seed ingredients (aqueous ingredients).
2) Blend MCT oil, melted whole butter, and high oleic sunflower oil. Mixture may form a water-in-oil emulsion, due to the presence of aqueous butter fraction.
3) While vigorously mixing aqueous ingredients, slowly add MCT/whole butter/sunflower oil blend.
Total non-oil ingredients: 894 grams (ABF is a non-oil ingredient)
Total oil ingredients: 1888 grams
Oil content: 68%
MCT/SF ratio: 48.8%/51.2%
Vegetable oil content (of oil component): 12%
Result: Stable mayonnaise with good resistance to oil leakage from temperature cycling. Oil leakage resistance better than examples 2 and 3.

### EXAMPLE 5

170 grams pasteurized egg yolks

200 g pasteurized egg whites

100 g lemon juice

250 g vinegar (5% strength)

12 g salt

12 g mustard seed

1000 g whole butter (comprising about 850 g butter oil and 150 g ABF)

812 g MCT oil

500 g high oleic sunflower oil

### Method:

1) Blend yolks, whites, lemon juice, water, vinegar, salt and mustard seed ingredients (aqueous ingredients).
2) Blend MCT oil, melted whole butter, ascorbyl palmitate and high oleic sunflower oil. Mixture may form a water-in-oil emulsion, due to the presence of aqueous butter fraction.
3) While vigorously mixing aqueous ingredients, slowly add MCT/whole butter/sunflower oil blend.
Total non-oil ingredients: 894 grams
Total oil ingredients: 2162 grams
Oil content: 71%
MCT/SF ratio: 48.8%/51.2%
Vegetable oil content (of oil component): 30%
Result: Stable mayonnaise with good resistance to oil leakage from temperature cycling. Oil leakage resistance is better than examples 2 and 3.

In another embodiment, the mayonnaise contains up to about 0.5% ascorbyl palmitate, a fat-soluble form of vitamin C. Ascorbyl palmitate has been observed to reduce the size of fat crystals that form in MCT-butter oil combinations during refrigeration. It has also been discovered by the present inventor that ascorbyl palmitate tends to reduce oil leakage and emulsion instability after multiple refrigeration-warming cycles. Ascorbyl palmitate unexpectedly and surprisingly improves the emulsion stability.

It is believed that ascorbyl palmitate improves emulsion stability by reducing the size and increasing the number of fat crystals that form inside the oil phase. This is believed because the oil mixtures used for the present mayonnaise have much smaller crystal sizes when ascorbyl palmitate is added. Small crystals have a lower tendency to cause oil droplet coalescence and oil leakage than large crystals, particularly if the fat crystals are small compared to the oil droplet size. Preferably, the fat crystals are much smaller than the oil droplets (e.g. have maximum dimensions of less than ½ a typical oil droplet diameter), such that they are entirely contained within the oil droplets.

Hence, by reducing the size of fat crystals, ascorbyl palmitate tends to improve emulsion stability. However, the present invention is not limited to this specific theory of how ascorbyl palmitate improves emulsion stability.

### EXAMPLE 6

170 grams pasteurized egg yolks

200 g pasteurized egg whites

100 g lemon juice

250 g vinegar (5% strength)

12 g salt

12 g mustard seed

1000 g whole butter (comprising about 850 g butter oil and 150 g ABF)

812 g MCT oil

500 g high oleic sunflower oil

5.8 g ascorbyl palmitate

### Method:

1) Blend yolks, whites, lemon juice, water, vinegar, salt and mustard seed ingredients (aqueous ingredients).
2) Blend MCT oil, melted whole butter, ascorbyl palmitate and high oleic sunflower oil. Mixture may form a water-in-oil emulsion, due to the presence of aqueous butter fraction. Ascorbyl palmitate tends to reduce the water droplet size in this emulsion and enhance emulsion formation.
3) While vigorously mixing aqueous ingredients, slowly add MCT/whole butter/sunflower oil/ascorbyl palmitate emulsion.
Total non-oil ingredients: 900 grams (ascorbyl palmitate is considered a non-oil ingredient)
Total oil ingredients: 2162 grams
Oil content: 71%
MCT/SF ratio: 48.8%/51.2%
Vegetable oil content (of oil component): 30%
Result: Stable mayonnaise with good resistance to oil leakage from temperature cycling. Oil leakage resistance is better than examples 4 and 5.

### EXAMPLE 7

120 grams pasteurized egg yolks

138 g pasteurized egg whites

15 g concentrated lemon juice (40% citric acid)

15 g vinegar (20% strength)

15 g salt

15 g honey

5 g mustard seed

1 g sodium phytate

45 g high oleic sunflower oil

1.5 g ascorbyl palmitate

### Method:

1) Blend yolks, whites, lemon juice, water, vinegar, salt and mustard seed ingredients (aqueous ingredients).
2) Blend MCT oil, melted whole butter, ascorbyl palmitate and high oleic sunflower oil. Mixture may form a water-in-oil emulsion, due to the presence of aqueous butter fraction. Ascorbyl palmitate tends to reduce the water droplet size in this emulsion and enhance emulsion formation.
3) While vigorously mixing aqueous ingredients, slowly add MCT/whole butter/sunflower oil/ascorbyl palmitate emulsion.
Total non-oil ingredients: 393 grams (ascorbyl palmitate is considered a non-oil ingredient)
Total oil ingredients: 852 grams
Oil content: 68%
MCT/SF ratio: 53%/47%
Vegetable oil content (of oil component): 5%
Sodium phytate content: 0.12%
Result: Stable mayonnaise with good resistance to oil leakage from temperature cycling. Oil leakage resistance is better than examples 4, 5 and 6. Sodium phytate at this concentration improves emulsion stability.

In another aspect of the invention, the mayonnaise contains an iron-chelating ingredient for inhibiting iron-catalyzed lipid peroxidation. This can dramatically increase shelf life. Suitable chelators include ethylenediaminetetraacetic acid (EDTA), sodium phytate, phytic acid, or green coffee bean extract (chlorogenic acid). Additionally, antioxidant substances can be added such as vitamin E, rosemary extract or the like.

It has been discovered by the present inventor that sodium phytate, when added in an amount of 0.06-0.16% greatly improves the emulsion stability and resistance to oil leakage from temperature cycling. Amounts of sodium phytate larger than about 0.2% tend to reduce emulsion stability. This is surprising and unexpected.

Sodium phytate is a preferred mineral chelator because it is a natural substances derived from rice bran and because it is very effective at binding iron and inhibiting iron-catalyzed lipid peroxidation. Sodium phytate can be added in an amount up to about 0.2%.

It is noted that phytic acid or other free phytate ion source can be used in place of sodium phytate. The sodium ion dissociates from the phytate ion. It is the phytate ion that chelates minerals and inhibits oxidation. Sodium phytate comprises about 70% by weight phytate ion and 30% by weight sodium. Accordingly, an amount of phytate ion equivalent to 0.06-0.16% sodium phytate is 0.042-0.112%.

It will be clear to one skilled in the art that the above embodiments may be altered in many ways without departing from the scope of the invention. Accordingly, the scope of the invention should be determined by the following claims and their legal equivalents.

What is claimed is:

1. An oil-in-water emulsion mayonnaise food product, comprising:
1) a continuous, acidic aqueous phase with a pH in the range of 3.0-4.6;
2) egg yolks and egg whites;
3) a discontinuous oil phase made of oil droplets, wherein the oil phase comprises:
a) medium-chain triglyceride (MCT) oil, and
b) a SF selected from the group consisting of butter oil, coconut oil, lard and palm oil;
wherein the MCT oil and SF are present in a ratio in the range 35-85% MCT:15-65% SF.

2. The food product of claim 1 wherein the MCT and SF are present in a ratio in the range 40-60% MCT:60-40% SF.

3. The food product of claim 1 wherein the discontinuous oil phase further comprises 10-25% vegetable oil selected from the group consisting of high oleic safflower oil, high oleic sunflower oil and olive oil.

4. The food product of claim 1 wherein the discontinuous oil phase further comprises up to 40% vegetable oil having a freezing temperature less than 45 degrees F.

5. The food product of claim 1 further comprising up to 0.5% ascorbyl palmitate.

6. The food product of claim 1 further comprising sufficient ascorbyl palmitate to cause fat crystals to be smaller than an oil droplet size when the mayonnaise food product is cooled to 40F for 24 hours.

7. The food product of claim 1 further comprising 0.06-0.16% sodium phytate or equivalent amount of phytate ion.

8. An oil-in-water emulsion mayonnaise food product, comprising:
1) a continuous, acidic aqueous phase with a pH in the range of 3.0-4.6;
2) egg yolks and egg whites;
3) a discontinuous oil phase made of oil droplets, wherein the oil phase comprises:
a) medium-chain triglyceride (MCT) oil, and
b) butter oil,
wherein the MCT and butter oil are present in a ratio of 35-85% MCT:15-65% butter oil,
4) aqueous butter fraction (ABF),
wherein the butter oil and aqueous butter fraction are present in a ratio in the range of 75-90% butter oil:10-25% ABF.

9. The food product of claim 8 wherein the MCT and SF are present in a ratio in the range 40-60% MCT:60-40% SF.

10. The food product of claim 8 wherein the discontinuous oil phase further comprises 10-25% vegetable oil selected from the group consisting of high oleic safflower oil, high oleic sunflower oil and olive oil.

11. The food product of claim 8 wherein the discontinuous oil phase further comprises up to 40% vegetable oil having a freezing temperature less than 45 degrees F.

12. The food product of claim 8 further comprising up to 0.5% ascorbyl palmitate.

13. The food product of claim 8 further comprising sufficient ascorbyl palmitate to cause fat crystals to be smaller than an oil droplet size when the mayonnaise food product is cooled to 40F for 24 hours.

14. The food product of claim 8 further comprising 0.06-0.16% sodium phytate or equivalent amount of phytate ion.

15. An oil-in-water emulsion mayonnaise food product, comprising:
1) a continuous, acidic aqueous phase with a pH in the range of 3.0-4.6;
2) an emulsifier comprising egg yolks and egg whites;
3) whole butter comprising butter oil and aqueous butter fraction (ABF) in a ratio in the range of 75-90% butter oil:10-25% ABF;
4) MCT oil;
wherein the MCT and butter oil are present in a ratio of 35-85% MCT:15-65% butter oil; and
wherein the MCT oil and butter oil are present in a discontinuous oil phase made of oil droplets.

16. The food product of claim 15 wherein the MCT and SF are present in a ratio in the range 40-60% MCT:60-40% SF.

17. The food product of claim 15 wherein the discontinuous oil phase further comprises 10-25% vegetable oil selected from the group consisting of high oleic safflower oil, high oleic sunflower oil and olive oil.

18. The food product of claim 15 wherein the discontinuous oil phase further comprises up to 40% vegetable oil having a freezing temperature less than 50 degrees F.

19. The food product of claim 15 further comprising up to 0.5% ascorbyl palmitate.

20. The food product of claim 15 further comprising sufficient ascorbyl palmitate to cause fat crystals to be smaller than an oil droplet size when the mayonnaise food product is cooled to 40F.
